(19) United States
(12) Patent Application Publication
(10) Pub. No.: US 2019/0381819 A1
(43) Pub. Date: Dec. 19, 2019

(54) Rotary Screen Pattern Printing of Polyurethane Resin onto Textiles

(71) Applicant: Sage Automotive Interiors, Inc., Greenville, SC (US)

(72) Inventors: David Michael Brown, Greenville, SC (US); Durwin G. Dawson, Williamston, SC (US); Julie Amanda Jacobs, Moore, SC (US); Carlos Edwin Green, Easley, SC (US); Tracey G. Hill, Inman, SC (US)

(21) Appl. No.: 16/479,475

(22) PCT Filed: Jan. 17, 2018
(86) PCT No.: PCT/US18/13979

§ 371 Date: Jul. 19, 2019

Related U.S. Application Data
(60) Provisional application No. 62/447,019, filed on Jan. 17, 2017.

(51) Int. Cl. B41M 1/30; B41F 15/08; B41F 15/38; B41F 15/42; B41M 3/00; D06M 15/564; D06P 1/52

(52) U.S. Cl. CPC B41M 1/30; B41F 15/0836; B41F 15/38; D06M 23/16; B41M 3/006; D06M 15/564; D06P 1/5285; B41F 15/426

(57) ABSTRACT

A PU printing method and system including a textile component; and a rotary screen device component. More specifically, the system can include: a source of PU material; a rotary screen containing a squeegee blade or magnetic roller that is connected to the PU material source; means to carry the textile in proximity to the rotary screen and in position to receive a print; and a source of pressure, hydrodynamic or magnetic, to force the PU through the rotary screen and onto the textile.

### CROSS REFERENCE TO RELATED APPLICATIONS:

This application claims the benefit of priority of U.S. Provisional application No. 62/447,019, filed on Jan. 17, 2017, which is incorporated herein in its entirety.

### BACKGROUND OF THE INVENTION:

The present invention relates generally to rotary screen pattern printing devices and methods.

Printing using polyurethane (“PU”) containing materials typically involves printing on paper substrates, not textile substrates. Further, PU patterns have been accomplished through such techniques as thermal welding or heat transfer, applique, flatbed, and three dimensional printing. However, rotary screen printing is not commonly used for this purpose.

Herein, “rotary screen printing” is defined as printing achieved by applying paste through a permeable screen onto a moving web. The paste is forced through a screen by magnetic bars or with blade squeegees as the substrate material passes beneath the screen.

Rotary screen printing has a vast range of design capabilities and coloration options that make it a desirable process for many applications, including automotive and apparel. Generally, rotary screen printing is a more efficient process for mass production. For example, some transfer methods require two distinct steps: first, the pattern is adhered to a transfer sheet, and second, the transfer sheet is combined with the substrate to apply the pattern. Similarly, other methods require piece meal printing (one section at a time) or an additional preparation step. By contrast, the rotary screen method allows for continuous printing directly on the substrate material.

Accordingly, these and other concerns show there is a need for an effective printing process and resulting product in the area of rotary screen printing, especially with the use of PU containing materials and textiles.

### SUMMARY OF THE INVENTION:

The following presents a simplified summary of the invention in order to provide a basic understanding of some aspects of the invention. This summary is not an extensive overview of the invention. It is not intended to identify key or critical elements of the invention or to delineate the scope of the invention; its sole purpose is to present concepts of the invention in a simplified form as a prelude to the more detailed description that is subsequently presented.

The present invention includes a method for printing a pattern, and, in particular, for applying a pattern of polyurethane (PU) containing material through a rotary screen onto a textile material.

In one embodiment of the method of the present invention, the steps of the invention may include the steps of: preparing a textile material; preparing a PU resin; providing a rotary screen printing device; feeding the textile material into the rotary screen printing device; and applying a pattern of the PU resin to the textile with the rotary screen printing device according to certain device parameters.

The rotary screen printing device may include: a rotary screen having a mesh with openings that correspond to the pattern being applied to the textile; a magnetic bar or blade squeegee contained by the rotary screen; a movable support to carry a textile web, a source of PU resin connected to the squeegee; and a source of magnetic or hydrodynamic pressure beneath the magnetic bar or blade squeegee, respectively, to force the PU resin through the screen. Further, the device speed, the roller size, the screen magnet, the magnet pressure, and temperature being parameters that can change to achieve the desired pattern targets, including thickness of print (height), clarity of print, and tactile properties of print.

In one embodiment of the system of the present invention, the components of the invention may include: a PU printing material component; a textile component; and a rotary screen device component. More specifically, the system may include: a source of PU resin or paste; a rotary screen containing a squeegee blade or magnetic roller that is connected to the PU resin source; means to convey the textile under the rotary screen and in position to receive a printing pattern; and a source of pressure, hydrodynamic or magnetic, beneath and proximate to the rotary screen.

One feature of the present invention is to provide a continuous method and system to apply PU patterns to textile fabrics. Another feature is to provide a rotary screen printing method and system that provides aesthetic enhancement to textiles, including various colors and designs. Another feature is to provide a rotary screen printing method and system that achieves more efficient mass production of patterned materials.

Other features and their advantages will be readily apparent to those skilled in the arts, techniques and equipment relevant to the present invention from a careful reading of the Detailed Description of Preferred Embodiments.

### BRIEF DESCRIPTION OF DRAWINGS

In the Drawings:

FIG. 1 is a perspective view of a rotary screen printing assembly according to an embodiment of the present invention;

FIG. 2 is a perspective view of a rotary screen component of a rotary screen printing assembly according to an embodiment of the present invention;

FIG. 3 is a schematic view of a rotary screen assembly according to an embodiment of the present invention;

FIG. 4 is a detailed view of a section of a rotary screen component of a rotary screen printing assembly according to an embodiment of the present invention;

FIG. 5 is a perspective view of rotary screen components for use in a rotary screen printing assembly according to an embodiment of the present invention;

FIG. 6 is a perspective view of a rotary screen assembly according to an embodiment of the present invention;

FIG. 7 is a perspective view of a rotary screen assembly according to an embodiment of the present invention;

FIG. 8 is a perspective view of a squeegee pressure blade component of a rotary screen assembly according to an embodiment of the present invention;

FIG. 9 is a perspective view of a pattern design on a textile material formed by a rotary screen assembly according to an embodiment of the present invention;

FIG. 10 is a perspective view of a pattern design on a textile material formed by a rotary screen assembly according to an embodiment of the present invention;

FIG. 11 is a perspective view of a pattern design on a textile material formed by a rotary screen assembly according to an embodiment of the present invention;

FIG. 12 is a perspective view of a pattern design on a textile material formed by a rotary screen assembly according to an embodiment of the present invention;

FIG. 13 is a perspective view of a pattern design on a textile material formed by a rotary screen assembly according to an embodiment of the present invention;

FIG. 14 is a perspective view of a pattern design on a textile material formed by a rotary screen assembly according to an embodiment of the present invention;

FIG. 15 is a perspective view of a pattern design on a textile material formed by a rotary screen assembly according to an embodiment of the present invention;

FIG. 16 is a perspective view of a pattern design on a textile material formed by a rotary screen assembly according to an embodiment of the present invention;

FIG. 17 is a perspective view of a pattern design on a textile material formed by a rotary screen assembly according to an embodiment of the present invention;

FIG. 18 is a perspective view of a pattern design on a textile material formed by a rotary screen assembly according to an embodiment of the present invention;

FIG. 19 is a perspective view of a pattern design on a textile material formed by a rotary screen assembly according to an embodiment of the present invention;

FIG. 20 is a perspective view of a pattern design on a textile material formed by a rotary screen assembly according to an embodiment of the present invention;

FIG. 21 is a perspective view of a pattern design on a textile material formed by a rotary screen assembly according to an embodiment of the present invention;

FIG. 22 is a perspective view of alternative squeegee components in a rotary screen assembly according to an embodiment of the present invention;

FIG. 23 is a perspective view of a single screen printer counter roller assembly according to an embodiment of the present invention; and

FIG. 24 is a schematic view of a rotary screen assembly and printing method according to an embodiment of the present invention.

### DETAILED DESCRIPTION OF PREFERRED EMBODIMENT:

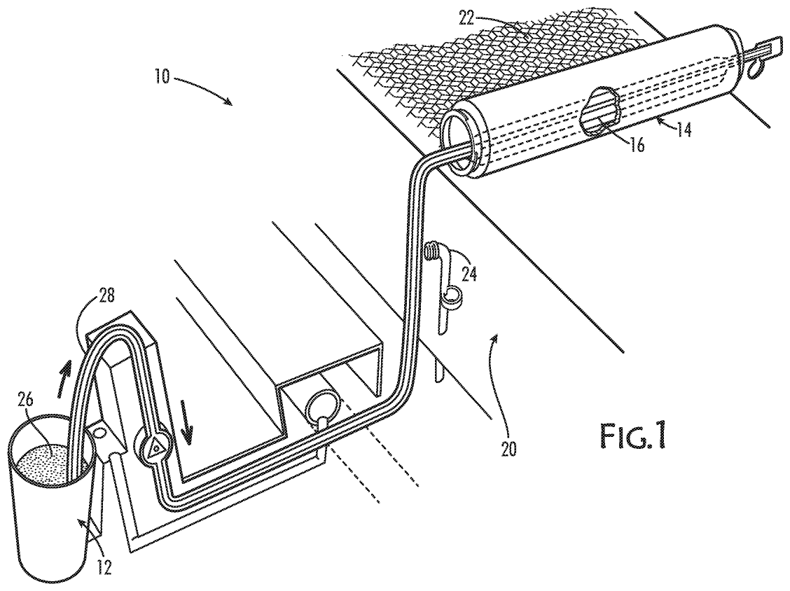

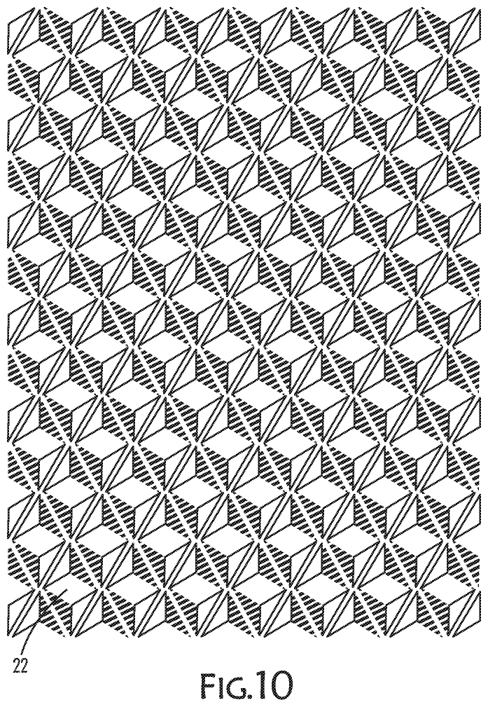

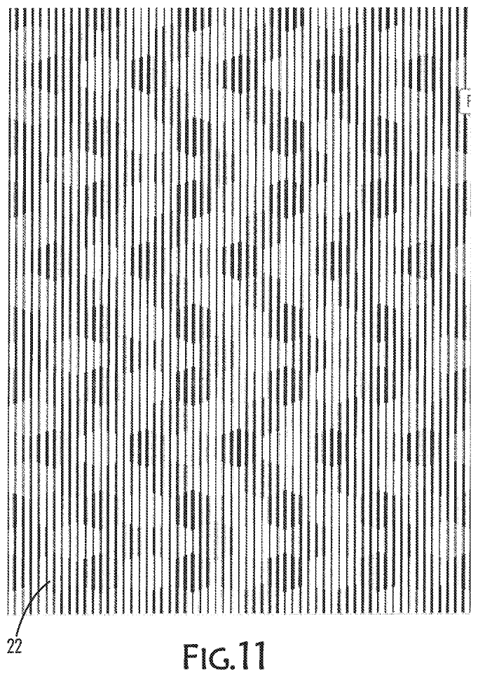

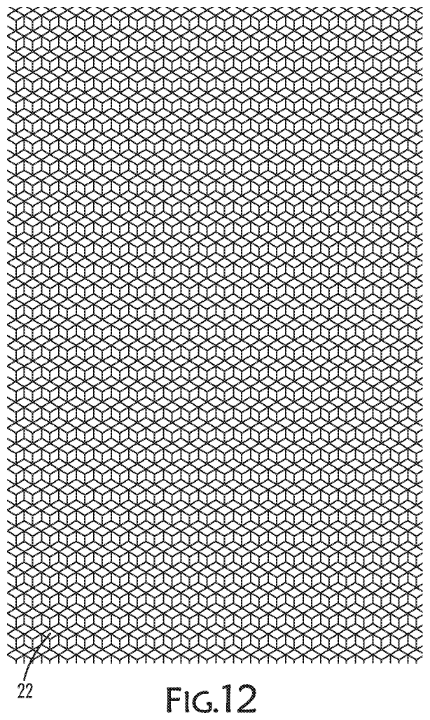

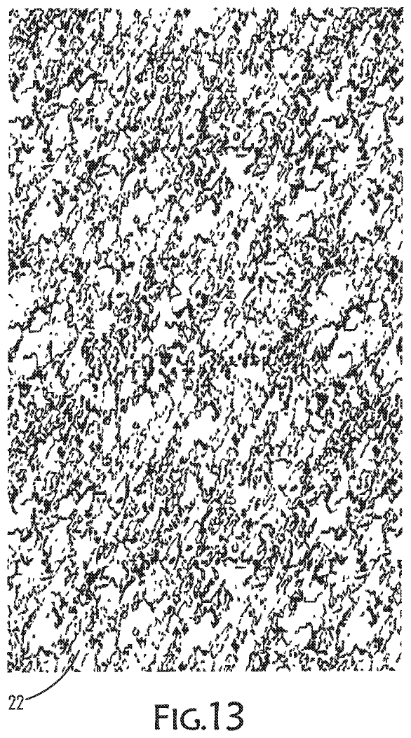

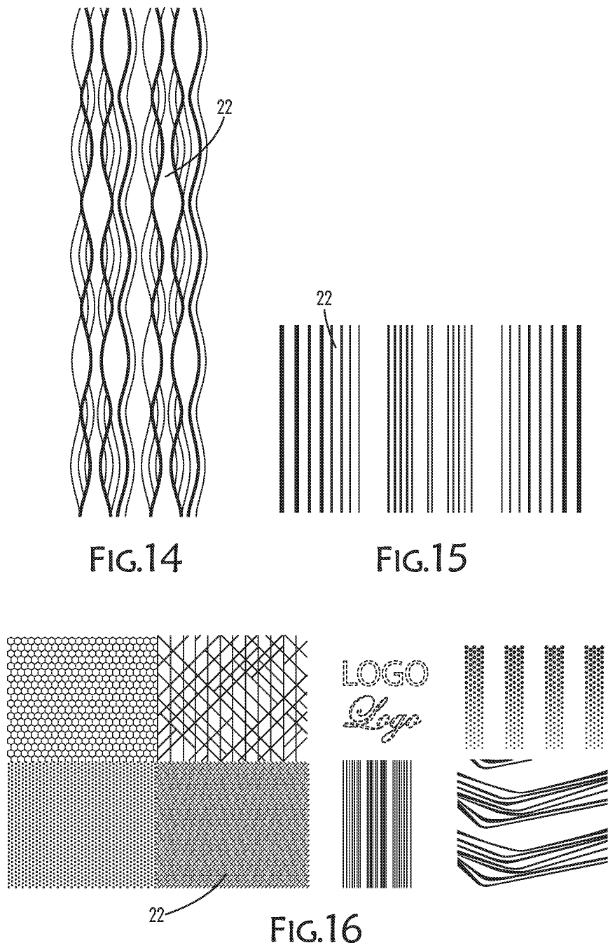

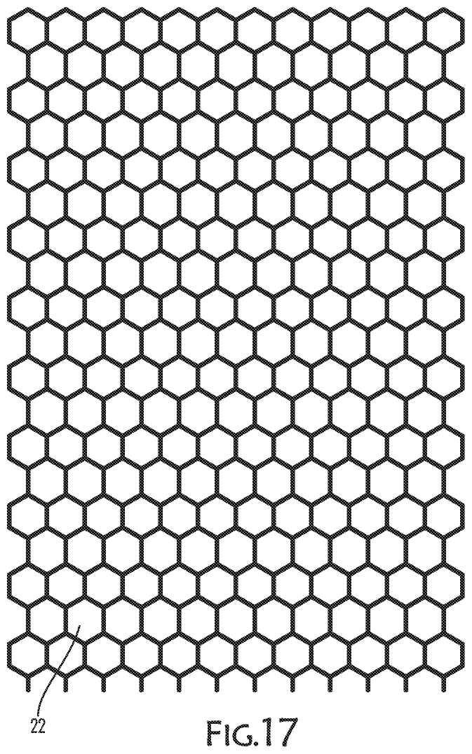

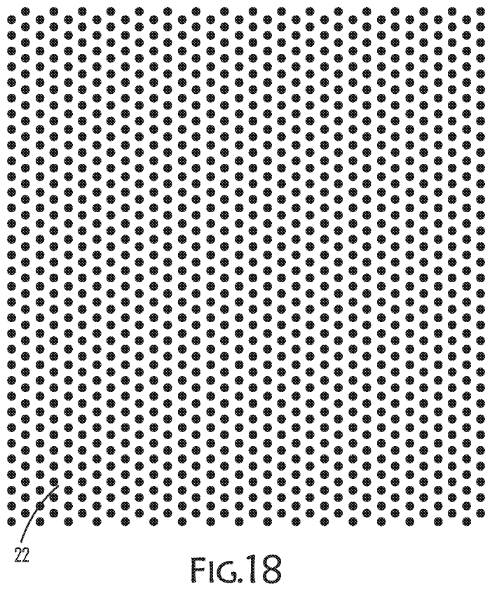

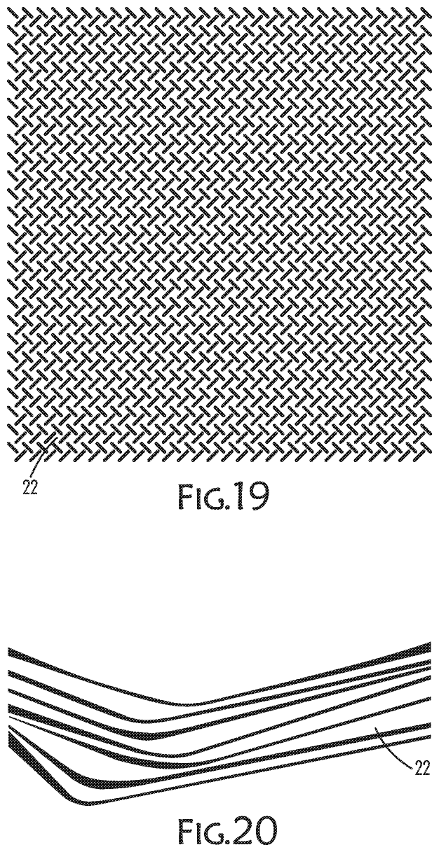

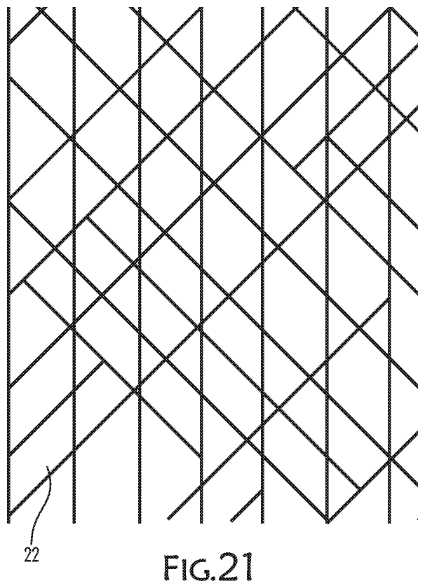

The present invention includes methods, apparatuses and systems relating to rotary screen printing of textile fabrics. Alternative embodiments of the present invention and its components are illustrated in FIGS. 1-24 and described more fully below.

The use of polyurethane (PU) containing materials for printing or transferring images, indicia or patterns has primarily been done on paper substrates, rather than textiles. Further, the printing methods used for these types of materials have typically included three dimensional, thermal welding or heat transfer, applique, and flatbed printing. The present invention introduces a printing method and system for utilizing rotary screen printing of PU containing materials onto textile materials.

Generally, the present invention may include a method and/or system for printing with the application of a PU resin or paste through a rotating, permeable screen onto a moving web of textile. The permeable screen may include a hollow, perforated, metal cylinder through which a PU material is forced, such as with magnetic bars or blade squeegees, that are contained within the cylinder. Proximate or beneath the cylinder may be a source of pressure, such as hydrodynamic or magnetic, that is applied to force the PU material through the perforations as a textile layer passes beneath the cylinder as it is rotated. With a blade squeegee, hydrodynamic pressure may be exerted on the blade to push the blade in the direction of the moving web. With a magnet roller, a magnetic force may be exerted on a roller to pull in the direction of a moving web.

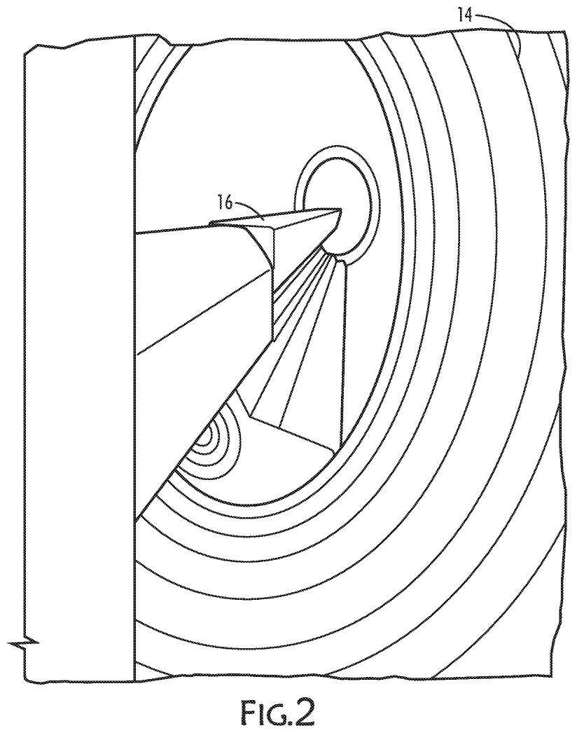

In one exemplary embodiment illustrated in FIG. 1, an example of a rotary printing system and assembly 10 of the present invention is shown, which may include the following components: a PU resin or paste component; a rotary screen component; a moveable web component; and a pressure component. For example, as in FIG. 1, a rotary printing device and system 10 may include: a source of PU resin or paste 12; a rotary screen 14 containing a squeegee blade (shown) or magnetic roller 16 that may be connected to the PU resin source 12; means to convey a textile sheet or web under the rotary screen 14 and in position to receive a printing pattern 22; and a source of pressure 24, hydrodynamic or magnetic beneath and proximate to the rotary screen 14. In one embodiment, a PU paste 26 is pumped from the PU resin source 12 through connecting tubes 28 into the squeegee or magnet roller 16, one example of a squeegee being shown in FIG. 2.

For each system component, alternative embodiments are contemplated by the present invention to achieve a particular print. For example, in one embodiment, the PU paste may be a water based paste with a viscosity and rheology adapted for effective transfer through a rotary screen 14 and onto a textile surface. In still another embodiment, the PU paste may include pigment colorants to impart color to a predetermined or desired print. In yet another embodiment the PU paste may be a puff based to impart dimensional aspects to the print. In one specific example, the PU paste may have a viscosity in the range of about 8,000 cps (centipoise) to about 19,000 cps. In this example, the viscosity was measured by a Brookfield viscometer with a #6 spindle at 20 rpms. Additionally, the level of PU paste used will vary depending on the dimensions of the pattern and/or design at issue.

The textile component may also vary. In one embodiment, textile component may include a flat, or pile/knit, or woven textile bearing a coating on which a PU pattern is applied. In one example, the coating of the textile may be such that PU materials rest and adhere to the surface of the textile, including the textile's top or upper surface, without significant adsorption by the textile, including into the base or lower surface of the textile. In one embodiment, the textile coating may include an amount of fluorocarbon. In another embodiment, the fluorocarbon may make up be about 1 to about 12% of the coating mixture. In still another embodiment, the coating component may include wax emulsions or non-fluorinated water repellants.

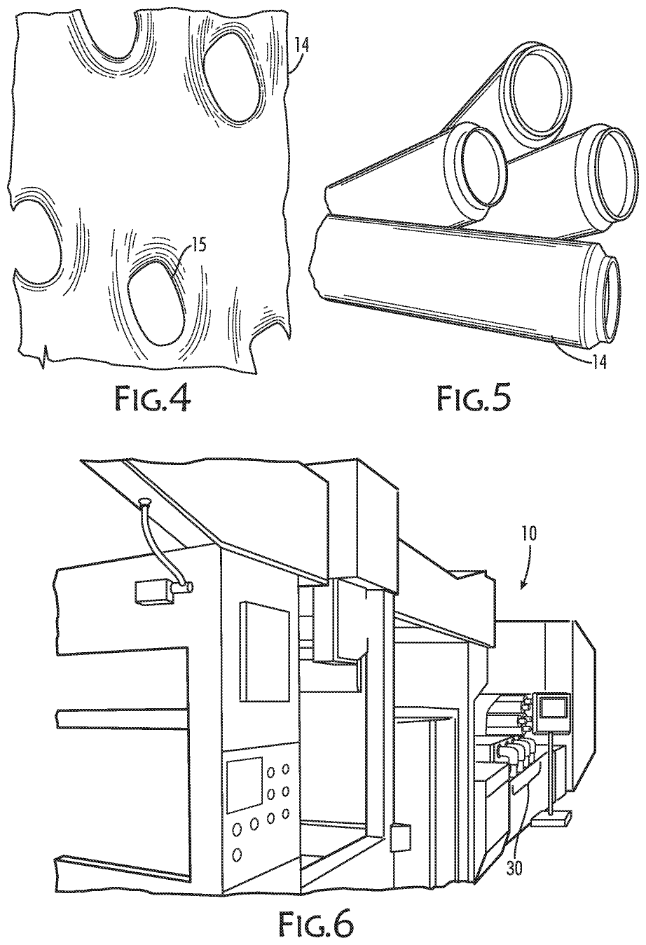

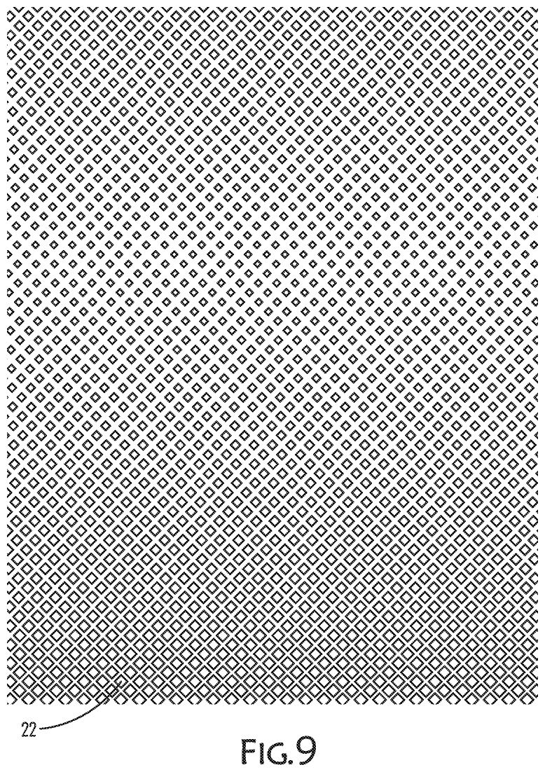

The rotary screen component may vary according to the print pattern and textile at issue. In one embodiment, the rotary screen 14 may be a metal cylinder with a mesh having perforations 15, such as shown in FIGS. 4-5. The circumference and width of the cylinders may be adapted to print a predetermined design or pattern 22. Further, the surface of the screen 14 may be cut, such as by laser, to include openings 15 corresponding to a predetermined design or pattern 22. Examples of various designs and patters 22 contemplated are shown in FIGS. 9-21. These indicate that a wide variety of shapes and patterns may be achieved by the present invention, and still others are contemplated and not shown, depending on variations to the recited components and parameters.

The screen may be made of metal, such as nickel. The strength or stiffness of the metal may vary depending on the type of textile and/or print at issue. Further, the screen 14 may include a coating, such as a lacquer coating, which may vary in thickness depending on the print to be achieved.

Generally, the size of the mesh hole in the screen may affect what the add-on amount of PU paste needed to achieve a pattern 22 and a sharpness of a printed pattern 22. The lacquer coating used may generally affect the longevity and clarity of the print, as well.

In one example, a rotary screen 14 mesh may be about 80 screen mesh (M), sometimes referred to as SP (units relating to holes per square centimeters), with about 40% or open (perforated or cut) area at about 150 microns in thickness, and having a hole diameter of about 201 microns. Other examples include a rotary screen 14 mesh in the range of about 60 to about 140 screen mesh, with an open area between about 10% to about 50%, at a screen thickness between about 100 to about 210 microns, and having a perforation hole diameter between about 80 to about 260 microns.

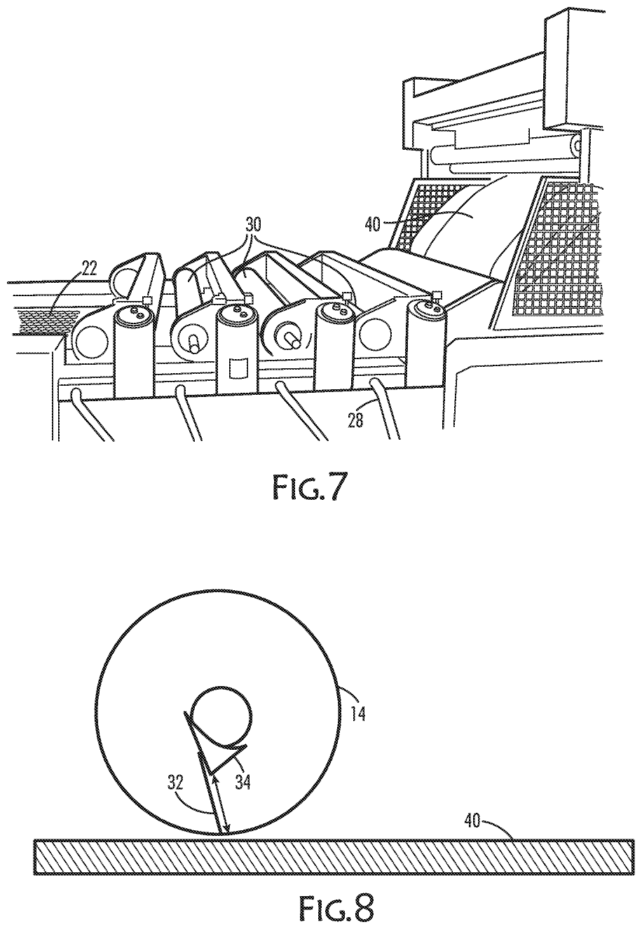

In another embodiment, the printing is done by one or more adjacent screens (shown in FIGS. 6-7), including a series of screens 30, that may work in tandem to complete a printing design or pattern 22. For example, if a printing pattern 22 includes multiple colors, the use of multiple screens 30 may be used so that each screen in the series 30 may be responsible for imparting a certain or different color into the multi-colored pattern. Alternatively, if a printing pattern includes distinct design shapes, such as lines and dots, using more than one screen to impart these different shapes is also possible. With more complicated patterns, the rotary printing parameters, including the rotation speed of the screens, as well as the position of the screens, may be adapted to be in synchronized registration. Similarly, the pattern size and repetition may be adjusted with the size of the screens.

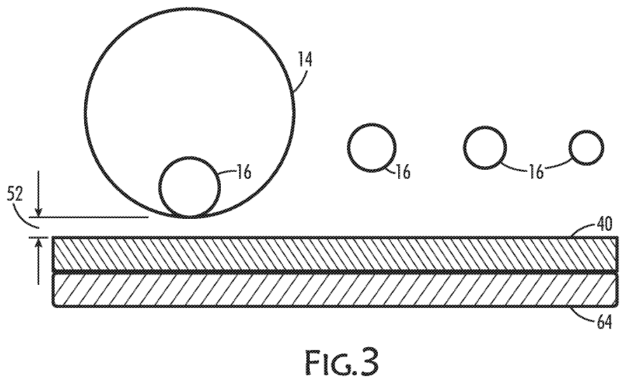

Other alternatives are contemplated in relation to the type and length of a squeegee or blade internal to a screen component 14 that serves to deliver a PU paste 26. When a magnet roller squeegee is used, the roller size and magnet pressure may be adjusted according to the desired print or design 22. For example, as shown in FIG. 3, multiple sizes of magnet rollers 16 may be used to determine the PU paste add-on amount and the sharpness of the print. Generally, a smaller roller will provide a sharper print with lower add-on of paste, whereas a larger roller will have the opposite effect. In one embodiment of the present invention, the magnet roller bar sizes may be between about 10 mm and about 40 mm. In another embodiment, the magnet rollers bars 16 may be 10 mm, 15 mm, 20 mm, or 30 mm.

The surface of the magnet roller may differ from smooth to textured or knurled. The smoother surfaces may be better for clear printing, while the cross-grained or textured surfaces are better when using larger amounts of PU paste when needed for certain prints.

In another embodiment, a rotary screen component 14 may be a squeegee that is a blade squeegee, such as an example shown in FIG. 8. As illustrated, the blade squeegee includes a blade 32 that is adjacent to a squeegee 34 that forces PU paste through the screen mesh. Generally, the length of the blade 32 helps determine the add-on amount of PU paste and the sharpness of the print. A short blade may result in shaper print and a lower add-on, and a longer blade may result in a less sharp, softer print and a higher add-on.

Furthermore, squeegee pressure may be adjusted depending on the amount of PU paste and printing definition that is needed. For blade squeegees, the flexing of the blade 32 in relation to the squeegee 34 with increased pressure. Alternatively, a roller size and magnet strength of a magnet roller can be adjusted for similar results. Generally, the higher the squeegee pressure the higher the PU paste add on and the lower the printing definition, and the lower the squeegee pressure the lower the add-on and higher the printing definition. In one embodiment, the roller squeegee pressure may range from between about 30% to about 80%.

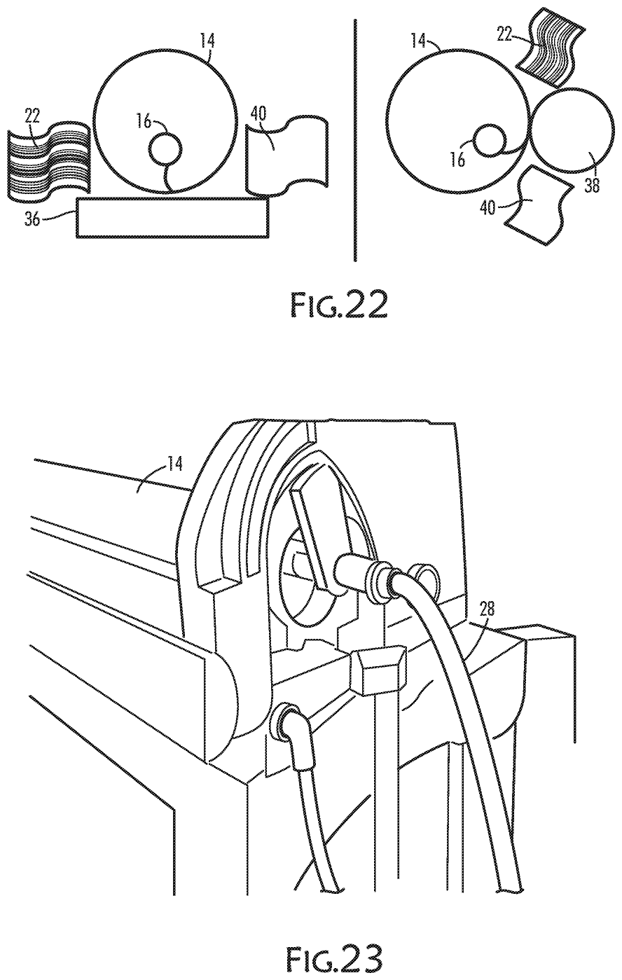

Further alternatives to a squeegee component are contemplated by the present invention. For example, the squeegees discussed can be used in connection with a continuous belt 36 that carries a textile layer 40 (FIG. 22, left), or instead with a counter roller 38 so that the textile layer 40 passes between the magnet squeegee roller/blade 16 and the counter roller 38 during the printing as shown in FIG. 22 to the right.

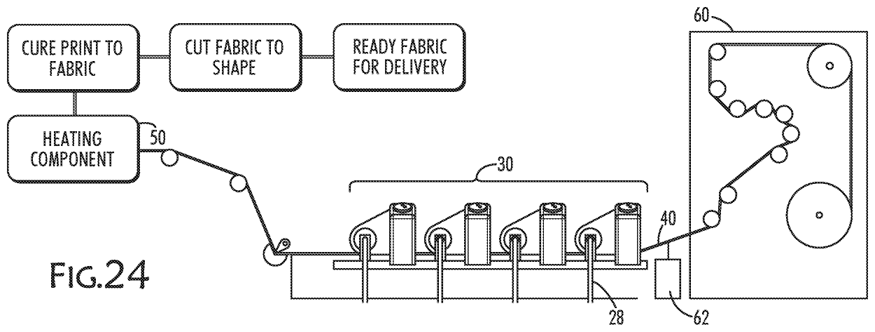

In addition to the forgoing components, the present invention contemplates a drying component 50 (FIG. 24) that is employed following the transfer of PU paste onto a textile, the parameters of which may vary. Such parameters as fan speed and temperature may determine the effectiveness and permanence of a predetermined print 22. The temperatures used can may also be adapted to arrive at a predetermined print. In one embodiment, the temperature of the dryer component 50 may be between about 130° C. and about 180° C. In another embodiment, the drying temperature may about 145° C.

In addition to alternatives among each component, which contribute to a certain desired print 22, the process parameters and/or how the components are combined to achieve the print may also vary. These features work in concert to arrive at a predetermined print.

In one embodiment, the web speed may be adapted to allow the textile layer 40 to pass under a rotary screen 14 and receive an effective amount of PU paste 26 to form a predetermined print 22 without substantial deviations. Herein, a “deviation” refers to any undesired attribute with the print, including without limitation inconsistent thickness, line breaks, smudges, and other ostensible departures from the predetermined design or pattern 22. In one embodiment, a web speed for a textile layer 40 may be between about 15 meters per minute to about 35 meters per minute. In another embodiment, the web speed may be about 25 yards per minute.

Another process parameter that may vary is a gap 52 or distance between a print screen 14 and a textile layer 40, also known as the print blanket, which rests on a moveable belt. Generally, increasing the gap 52, shown in FIG. 3, may result in increased PU paste volume being transferred to the textile surface. In one embodiment, the gap setting (distance between the screen to the belt) may be between about 0 to about 4 mm.

Furthermore, the surface tension of a textile layer 40 as it passes under a rotary screen 14 can be important to achieve a desired print 22. For example, rollers (FIG. 24) may be used in cooperation with a movable belt to maintain the textile, print blanket at a certain tension. Further, a belt used to carry the textile may include an adhesive layer to maintain the print blanket in place during printing. For example, a conveying means such as a moveable belt may include a thermoplastic layer that is activated by heat. In one embodiment, the textile layer 40 is first passed over a heating element or plate before coming into contact with the moving belt so as to activate the thermoplastic layer of the belt.

In addition to providing a system for printing PU containing materials onto a textile material, the present invention further contemplates a method for printing. In one embodiment the method of the present invention includes the steps of: providing a textile layer; providing a PU material; providing a rotary screen printing assembly; and transferring the PU material onto the textile layer according to a predetermined pattern using the rotary screen printing assembly.

In another embodiment of the present invention, the steps of the method include: providing a PU resin; preparing a PU paste adapted for printing; providing a textile material; preparing the textile material for printing with the PU paste; providing a rotary screen printing device; feeding the prepared textile material into the rotary screen printing device; applying a pattern of the PU paste to the textile with the rotary screen printing device according to certain device parameters; and drying the printed textile material according to certain device parameters.

The rotary screen printing device of one embodiment of the method may include: a print blanket feeder 60; one or more rotary screens 30 having a mesh with openings that correspond to the pattern being applied to the textile; a magnetic bar or blade squeegee contained by each of the one or more rotary screens; a movable support to carry a textile web, a source of PU paste connected to the squeegee; a source of magnetic or hydrodynamic pressure beneath the magnetic bar or blade squeegee, respectively, to force the PU paste through the screen; and a dryer 50. Further, the device speed, the roller size, the screen magnet, the magnet pressure, and temperature being parameters that may change to achieve the desired pattern targets, including thickness of print (height), clarity of print, and tactile properties of print.

In an exemplary embodiment, shown in FIG. 24, a rotary screen printing device as described above may further include the following features. In particular, a print blanket feeder 60 may include a series of moving rollers that cooperate to maintain the textile print blanket in proper alignment and tension as the blanket is fed to the movable support. The rotary screen printing device may further include a heat plate 62, such as one that is between the feeder 60 and the movable support. The movable support may include a layer of thermoplastic material that is activated by heat. Over the movable support may be positioned the one or more rotary screens, such as a series of screens 30. If more than one screen is included, the screens may be spaced apart and parallel to each other. The rotary screens may each contain a squeegee component that may be connected by a line 28 to a source of PU paste. The PU paste may be contained in a vessel and pumped through the line 28 to the squeegee for printing. Beneath and in proximity to each squeegee may be a source of hydrodynamic or magnetic pressure. For example, the device may include include a magnet beam 64 (FIG. 3) underneath the movable support. Lastly, the dryer component 50 may include a drying chamber housing one or more heating elements.

In another embodiment, the method of the present invention may include the following steps and features. An amount of PU resin may be used to form a PU print paste that is water based. Furthermore, a print blanket may be formed by treating a flat, or pile/knit, or woven textile layer with a coating or substance that provides water resistance to the surface of the textile. In particular, the coating or treatment of the textile may be such that PU materials rest and adhere to the surface of the textile without significant adsorption by the textile. In one embodiment, the coating includes a fluorocarbon compound. Alternatively, the coating may include a wax emulsion or a non-fluorinated water repellant substance. The treated print blanket may then be fed through a series of aligning and tensioning bars and passed over a heat plate. The heated print blanket may then contact and become releasably adhered to the surface of a movable support, such surface having a thermoplastic material or layer adapted to releasably maintain the print blanket in place during printing. The print blanket may then be passed between the movable support and the rotary screen or series of screens. In one embodiment, the movable support may be a continuous belt. In another embodiment, the movable support may be a counter roller to the rotary screen. As the print blanket passes under or next to the rotary screen, PU paste may then be pumped from the PU vessel to an applying squeegee blade or roller internal to the rotary screen. During this step, a magnetic or hydrodynamic pressure between the internal squeegee roller or blade and the counter magnet source may be used to force the PU paste onto the print blanket as it passes beneath the screen to create a predetermined print. Next, the printed blanket may pass into a dryer, including a pressurized dryer, to perpetuate the print onto the textile.

In still another embodiment, the method of the present invention described above may be performed using certain process parameters, including web speed, drying temperature, and magnet pressure. In one exemplary embodiment, the process parameters may be as follows:
Print blanket speed of about 15 meters per minute;
Dryer temperature of about 125° C.;
Magnet pressure of about 15%;
A magnet roller is knurled and about 20 mm; and
A gap between the print side and the rotary screen is about 1.75 mm print side/1.25 mm wet side.

In yet another embodiment, the method of the present invention may also include the following steps: permanently fixing the print to the textile if needed, such as through additional heating or curing steps; modifying the printed textile sheet for a specific purpose, such as cutting the textile according to predetermined sizes; and transporting the modified textile for final application and use.

One feature of the present invention is the use of a unique rotary screen in combination with a PU print paste preparation and base pretreatment, along with the process parameters, including the setting of the print range. This combination provides the ability to print PU onto textile materials, which was previously not possible. Further, the mixing of the PU paste according to certain mixing specifications is a critical step to achieve a particular predetermined print.

Those skilled in the relevant arts will appreciate from the foregoing description of preferred embodiments that substitutions and modification can be made without departing from the spirit and scope of the invention which is defined by the appended claims.

What is claimed is:

1. A rotary screen printing system comprising:
a printing material component, wherein said printing material component includes a source of polyurethane containing paste;
a textile component including a layer of textile material;
and a rotary screen device component operatively connected to said printing material component and said textile component, wherein said rotary screen device component comprises:
a rotary screen that is a cylinder having openings, said openings defining an open space along the surface of said cylinder that corresponds to a predetermined printing pattern, said textile component adapted to receive said predetermined printing pattern, and said cylinder containing a squeegee blade or magnetic roller that is operatively connected to said source of polyurethane containing paste;
means to convey said textile component adjacent to said rotary screen;
a pressure source component having a source of hydrodynamic or magnetic pressure, said pressure source component cooperating with said squeegee blade or said magnetic roller to force an effective amount of said polyurethane containing paste through said rotary screen and onto said textile component to form a polyurethane based print having said predetermined printing pattern; and
a drying component operatively connected to said rotary screen component, said drying component adapted to set said polyurethane based print.

2. The rotary screen printing system as recited in claim 1, wherein said layer of textile is a flat, a pile, a knit, or a woven blanket.

3. The rotary screen printing system as recited in claim 2, wherein said layer of textile has a top surface and a lower surface, and wherein said layer of textile includes a coating adapted to receive said polyurethane based print only on said top surface of said layer of textile.

4. The rotary screen printing system as recited in claim 3, wherein said coating includes a fluorocarbon mixture.

5. The rotary screen printing system as recited in claim 4, wherein said fluorocarbon mixture includes an amount of fluorocarbon that makes up about 1% to about 12% of said fluorocarbon mixture.

6. The rotary screen printing system as recited in claim 3, wherein said coating is a non-fluorinated water repellant mixture, or a wax emulsion.

7. The rotary screen printing system as recited in claim 1, wherein said cylinder is made of nickel.

8. The rotary screen printing system as recited in claim 7, wherein said nickel is coated with lacquer.

9. The rotary screen printing system as recited in claim 1, wherein said polyurethane containing paste has a viscosity between about 8000 cps and about 19000 cps.

10. The rotary screen printing system as recited in claim 1, wherein said polyurethane containing paste includes an amount of pigment imparting material.

11. The rotary screen printing system as recited in claim 1, wherein said openings are perforations, a series of geometric shapes, a series of cuts, or a combination of perforations, geometric shapes and cuts.

12. The rotary screen printing system as recited in claim 1, wherein said open space is between about 10% to about 50% of said cylinder.

13. The rotary screen printing system as recited in claim 12, wherein said cylinder has a thickness between about 100 and about 210 microns.

14. The rotary screen printing system as recited in claim 13, wherein said openings are perforations with a hole diameter between about 80 to about 260 microns.

15. The rotary screen printing system as recited in claim 14, wherein said open space is about 40% of said cylinder, wherein said cylinder is about 150 microns in thickness, and wherein said hole diameter of said perforations is about 200 microns.

16. The rotary screen printing system as recited in claim 1, wherein said cylinder contains a magnetic roller that is between about 10 mm and about 40 mm.

17. The rotary screen printing system as recited in claim 16, wherein the surface of said magnetic roller is smooth, textured, or knurled.

18. The rotary screen printing system as recited in claim 1, wherein said rotary screen component includes a series of cylinders oriented parallel to each other.

19. A method for printing a textile layer with a PU material, comprising the steps of:
providing a polyurethane containing paste that is adapted for printing on textile material;
providing a textile material;
preparing said textile material for printing with said polyurethane paste;
providing a rotary screen printing device comprising:
a rotary screen that is a cylinder having openings, said openings defining an open space along the surface of said cylinder that corresponds to a predetermined printing pattern, said prepared textile material adapted to receive said predetermined printing pattern, and said cylinder containing a squeegee blade or magnetic roller that is operatively connected to said polyurethane containing paste;
a conveyor to move said textile component adjacent and leaving a gap in relation to said rotary screen; and
a source of hydrodynamic or magnetic pressure, said pressure source component cooperating with said squeegee blade or said magnetic roller to force an effective amount of said polyurethane containing paste through said rotary screen and onto said textile material to form a polyurethane based print having said predetermined printing pattern;
feeding said prepared textile material into said rotary screen printing device;
applying said predetermined print to said textile material with said the rotary screen printing device according to a set of device parameters; and
drying said printed textile material according to said set of device parameters.

20. The rotary screen printing method as recited in claim 19, wherein said textile material preparing step comprises applying a coating to said textile material so that said textile material is adapted to adhere said polyurethane paste without substantial adsorption by said textile material.

21. The rotary screen printing method as recited in claim 19, wherein said set of device parameters includes a conveyor speed for said conveyor of about 15 meters of textile material per minute and a drying temperatures for said drying step of about 125° C.

22. The rotary screen printing method as recited in claim 19, wherein said gap is between about 0 to about 4 mm.
